(19) United States
(12) Patent Application Publication
(10) Pub. No.: US 2026/0181583 A1
(43) Pub. Date: Jun. 25, 2026

(54) Method for Locating Mobile Devices in a UWB Localizing Network

(71) Applicant: Pinpoint GmbH, Chemnitz (DE)

(72) Inventor: Vinayak Shenoy, Chemnitz (DE)

(21) Appl. No.: 19/128,191

(22) PCT Filed: Dec. 5, 2023
(86) PCT No.: PCT/DE2023/100941

§ 371 Date: May 8, 2025

(30) Foreign Application Priority Data
Dec. 23, 2022 (DE) 10 2022 134 677.3

(51) Int. Cl. H04W 64/00; H04B 1/7163; H04W 12/037

(52) U.S. Cl. CPC H04W 64/00; H04B 1/7163; H04W 12/037

(57) ABSTRACT

The invention relates to a method for locating mobile devices in a UWB localising network, wherein the network is divided into clusters and each cluster has a plurality of network nodes such that the network nodes form a meshed network wherein —the network nodes arranged in a cluster are synchronised by means of synchronisation messages with an STS field and a data field within a cluster in the ultra wideband (UWB) by means of sending and receiving and—the position of the network nodes in the UWB localising network is known and the network nodes of a cluster generate a cluster position from the positions of the individual network nodes such that the cluster position is used for all network nodes of the cluster as an input variable for generating the STS field used in the synchronisation message.

### CROSS REFERENCE TO RELATED APPLICATIONS

This application is the U.S. national stage of International Application No. PCT/DE 2023/100941, filed on Dec. 5, 2023. The international application claims the priority of DE 102022134677.3 filed on Dec. 12, 2022; all applications are incorporated by reference herein in their entirety.

### BACKGROUND

The invention relates to a method for locating mobile devices in a UWB localizing network and is used in particular for locating mobile devices indoors.

GPS cannot be used for indoor locating due to roofing. Accordingly, networks for locating mobile devices, especially indoors, that use ultra-wideband technology (UWB) for communication between individual network nodes are known. Such locating networks typically consist of several stationary nodes, also known as satlets or anchors, which form the infrastructure of an indoor locating environment. Within such an infrastructure, it is possible to locate mobile devices such as tablets or cell phones or to enable them to locate themselves. This is done by sending and/or receiving UWB network messages to or from the infrastructure or indoor locating environment.

There are various approaches to how network messages are exchanged and used for localization. Common methods are the Two-Way-Ranging (TWR) method, the Time-Difference-of-Arrival (TDoA) method or the Reverse-TDoA method, which is sometimes also referred to as the Downlink (DL) TDoA method. TDoA-based methods require time synchronization of the infrastructure with nanosecond accuracy in order to be able to evaluate the signal propagation times of the radio signals, which propagate at the speed of light (1 light nanosecond corresponds to 30 cm).

Good radio propagation conditions are essential and necessary for wireless synchronization of the infrastructure. Under real operating conditions, complex building structures make it difficult to set up indoor locating systems that have to be equipped with a large number of infrastructure nodes and where radio propagation conditions are unpredictable. These include shadowing of the radio signals and line-of-sight losses between the nodes, e.g. due to walls.

Due to this fact, complex indoor locating environments are advantageously divided into clusters with good radio propagation conditions and manageable network sizes, while minimizing radio interference between the clusters. In addition, security aspects must be taken into account in order to protect indoor locating systems against intentional or unintentional interference.

A procedure known as scrambled-timestamp-sequence (STS) was introduced and standardized specifically for UWB systems (IEEE 802.15.4z standard). This procedure allows secure hardware-related time stamping of network messages, which is essential for network synchronization and locating mobile devices. Synchronization only takes place with nodes that use an identical STS pattern. The detailed structure of STS can be found in the document IEEE Std 802.15.4z-2020, IEEE Standard for Low-Rate Wireless Networks, Amendment 1: Enhanced Ultra Wideband (UWB) Physical Layers (PHYs) and Associated Ranging Techniques.

A device and method for generating an encrypted timestamp sequence in a UWB system are known from publication EP 4 054 114 A1, wherein the method involves assigning roles to the controller and controllee. This solution has a complicated design, as both a UWB communication channel for distance measurement and a non-UWB communication channel for network control and initialization are required. The non-UWB communication channel can be a BLE (Bluetooth Low Energy) connection, for example.

Furthermore, time-variable STS configurations are required on the devices of a radio network to secure UWB communication. These configurations are linked to a time slot, wherein the transmitter and receiver must have the same understanding of time. Only the time-variable STS is used. Another disadvantage is that the controller represents a single point of failure.

A communication method in the ultra-wideband and a communication device for the secure generation and management of a security key are known from the publication US 2022/0191700 A1. According to the method, a time stamp is generated on the basis of a first key, wherein the first communication between the devices takes place with the time stamp. Three parameters are used to generate the timestamp: phyHarpUwbStsKey, phyHrpUwbStsVUpper96 and phyHrpUwbStsVCounter.

### SUMMARY

It is the object of the invention to develop a method for locating mobile devices in a UWB localizing network, which has a simple design and provides an exact localization of mobile devices, especially in buildings.

This problem is solved with the features of the first claim.

Advantageous designs result from the subclaims.

### DETAILED DESCRIPTION

The method for locating mobile devices in a UWB localizing network has a network divided into clusters, wherein each cluster has a plurality of network nodes such that the network nodes form a meshed network. The network nodes arranged in a cluster communicate by means of synchronization messages, wherein the synchronization messages comprise an STS field and a data field and synchronize within a cluster in the ultra wideband (UWB) by transmitting and receiving, wherein the position of the network nodes in the UWB localizing network is known and the network nodes of a cluster generate a cluster position from the positions of the individual network nodes such that the cluster position for all network nodes of the cluster is used as an input variable for generating the STS field used in the synchronization message.

The STS field generates a coded signal pattern for time recording in the receiver. The data field transmits information between the transmitter and receiver.

In an advantageous design, the location is determined in a, particularly first, step by a rough positioning of the mobile device through the accessibility of network nodes located in a cluster and the reception of transmitted synchronization messages and the evaluation of the known position data of the network nodes contained in the synchronization message.

In a particularly advantageous design, the mobile device and the network nodes networked in a cluster are operated with the same STS parameters, wherein the exact positioning is carried out by recording and evaluating time information of spatially close network nodes, wherein the time measurement between the mobile device and the network nodes is carried out via the STS field. This can be done in particular after rough positioning.

Particularly preferably, the mobile device derives STS parameters from the rough positioning and the position data contained therein for STS generation.

Other parameters, such as key information, can also be included in the STS generation.

In an advantageous design, time information is also used as a parameter in the STS generation in addition to the position data. With such a design, a spatially/temporally variable STS is generated.

The time measurement between the devices is therefore carried out via the STS field. The network nodes serve as reference stations for the cluster.

In an advantageous design, the synchronization message can have a SYNC field in addition to the STS field and data field to initialize the time of the receiver. The sequence of the STS field and the data field can vary within the synchronization message.

In an advantageous design, different clusters use different STS sequences. This makes it possible to minimize the load, as there is no detection/handling of time stamps with time errors due to messages from neighboring clusters.

The cluster position is preferably generated by averaging the positions of the associated network nodes of a cluster and used as an input variable for STS generation. An average value is used, wherein the arithmetic mean value is calculated from all node positions of the cluster.

Alternatively, the cluster position can be calculated by forming a median value, wherein the positions of all network nodes are sorted and, as a result, the mean position of the cluster is then adopted. Another possibility is the use of cluster boundaries for STS generation, but other calculations of the cluster position are also conceivable, wherein the cluster position is basically determined as a derived position measure of the positions of the network nodes. The cluster position can be understood as a feature of STS generation derived from the positions of the network nodes.

STS generation is preferably carried out in accordance with the IEEE 802.15.4z standard, wherein the cluster position is included in the STS generation as a configuration parameter in a 96-bit input data field, in particular in the 96-bit input data field phyHrpUwbStsVUpper96.

Mobile devices require knowledge of the STS parameters of the respective cluster to locate them within the UWB localizing network.

In an advantageous design, a cluster is bounded by walls indoors in such a way that a spatially contiguous synchronization cluster is formed. This ensures good radio propagation conditions and thus high synchronization quality within the cluster.

Advantageously, the synchronization message is encrypted.

### BRIEF DESCRIPTION OF THE DRAWINGS

The invention is explained in more detail below using an exemplary embodiment and associated drawings, wherein:

FIG. 1 shows a schematic representation of a UWB localizing network,

FIG. 2 shows individual clusters with a spatial separation, and

FIG. 3 shows a flow chart.

### DETAILED DESCRIPTION OF THE PREFERRED EMBODIMENTS

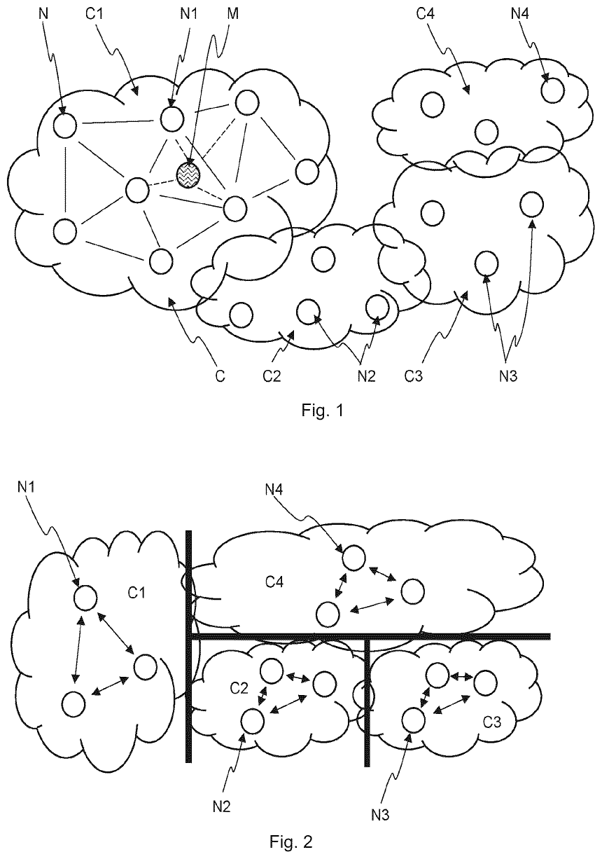

FIG. 1 shows a UWB localizing network, wherein the UWB localizing network is formed from several clusters C, in particular four clusters C1-C4 with network nodes N, in particular N1-N4, arranged therein. The network nodes N are interconnected within the respective cluster C, forming a meshed network. The network nodes N1-N4 are synchronized by means of sending and receiving synchronization messages, wherein the positions of the network nodes within the UWB localizing network are known. The network nodes therefore serve as reference stations for the rough localization of a mobile device.

The synchronization messages have a SYNC field, an STS field and a data field, from the positions of the individual network nodes N1-N4 a cluster position is generated, which is used as an input variable to generate the STS field used in the synchronization message. The cluster position is preferably the averaged cluster position in the UWB localizing network.

A mobile device M, for example a smartphone or similar, is arranged in the first cluster C1 and roughly localizes itself in the cluster C1 in a first step by detecting the surrounding network nodes N1 that can be reached. According to FIG. 1, four network nodes N1 are reached (shown as dashed lines).

By receiving the sent synchronization messages of the network nodes N1 and evaluating the known position data of the network nodes N1 contained in the synchronization message, the mobile device M locates the rough position. The rough positioning can be carried out with the proportionate accessibility of network nodes N1 by the mobile device M. The connection between the mobile device M and the accessible network nodes N1 is shown as a dashed line in FIG. 1. Since the mobile device M and the network nodes N1 networked in a cluster must be operated with the same STS parameters, the STS parameters for STS generation in the mobile device M are derived from the known position data of all network nodes N1 of the cluster C1.

In the next step, this data is used to determine the exact position of the mobile device M in the UWB localizing network after it has been roughly positioned.

This is done by recording and evaluating time information of the spatially close network nodes N1 (shown as dashed lines), wherein the time measurement between the mobile device and the network nodes takes place via the STS field.

FIG. 2 shows a UWB network with spatially separated clusters C1-C4. The individual clusters C1-C4 are bounded by walls W, which ensures good radio propagation conditions and thus high synchronization quality within the clusters C1-C4. Synchronization messages are sent and received between the individual network nodes N1-N4 for synchronization in the respective cluster. The individual clusters C1-C4 have different STS sequences. This makes it possible to minimize the load, as there is no detection/handling of time stamps with time errors due to messages from neighboring clusters. For example, the handling of synchronization messages from clusters C2 or C4 can be avoided in cluster C1.

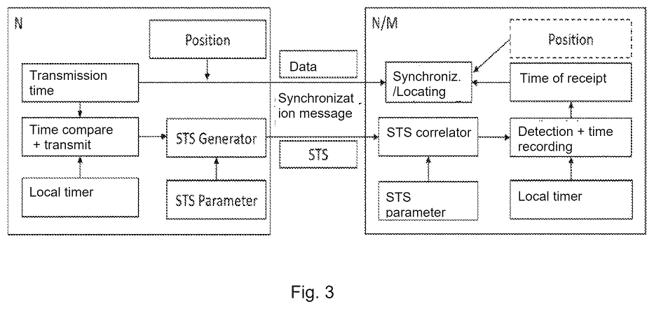

Synchronization and localization are shown schematically in FIG. 3. A network node N is designed as a transmitter. The transmitting network node transmits its own known position with a transmission time in the data field in the synchronization message. The receiver is either a further network node N or a mobile device M.

In the case of a network node N as the receiver, the known position (dashed) is used for synchronization. In the case of a mobile device, it locates itself in the network from the time of receipt of the components of the STS field of the synchronization message and the data of the data field. Time measurement for the time of reception is possible if the network node N acting as the transmitter and the network node N acting as the receiver or the mobile device M acting as the receiver are operated with the same STS parameters. These STS parameters are transferred to an STS generator in the transmitter and to an STS correlator in the receiver. The time is therefore measured via the STS field.

The STS generation scheme is based on IEEE 802.15.4z, wherein the cluster position is included in the STS generation as a configuration parameter in the 96-bit input data field phyHrpUwbStsVUpper96. The STS generation scheme is applied to both the STS generator of the transmitter and the STS correlator of the receiver.

LIST OF REFERENCE NUMERALS
C Cluster
C1 First cluster
C2 Second cluster
C3 Third cluster
C4 Fourth cluster
M Mobile device
N Network node
N1 Network node of the first cluster
N2 Network node of the second cluster
N3 Network node of the third cluster
N4 Network node of the fourth cluster

1.-12. (canceled)

13. Method for locating mobile devices in a UWB localizing network, wherein the network is divided into clusters (C) and each cluster (C) has a plurality of network nodes (N) such that the network nodes (N) form a meshed network, wherein the network nodes (N) arranged in a cluster (C) synchronize by means of synchronization messages with an STS field and a data field within a cluster (C) in the ultra wideband (UWB) by transmitting and receiving, wherein the position of the network nodes (N) in the UWB localizing network is known, characterized in that
the network nodes (N) of a cluster (C) generate a cluster position from the positions of the individual network nodes (N) in such a way that
the cluster position for all network nodes (N) of the cluster (C) is used as an input variable for generating the STS field used in the synchronization message and in that
a rough locating of the mobile device (M) is carried out by the accessibility of network nodes (N) located in a cluster (C) and the reception of transmitted synchronization messages and the evaluation of the known position data of the network nodes (N) contained in the synchronization message.

14. Method for locating mobile devices in a UWB localizing network, wherein the network is divided into clusters (C) and each cluster (C) has a plurality of network nodes (N) such that the network nodes (N) form a meshed network, wherein the network nodes (N) arranged in a cluster (C) synchronize by means of synchronization messages with an STS field and a data field within a cluster (C) in the ultra wideband (UWB) by transmitting and receiving, wherein the position of the network nodes (N) in the UWB localizing network is known, characterized in that
the network nodes (N) of a cluster (C) generate a cluster position from the positions of the individual network nodes (N) in such a way that
the cluster position for all network nodes (N) of the cluster (C) is used as an input variable for generating the STS field used in the synchronization message and in that
the mobile device and the network nodes (N) networked in a cluster (C) are operated with the same STS parameters and the exact positioning is carried out by recording and evaluating time information of spatially close network nodes (N), wherein the time measurement between the mobile device (M) and the network nodes (N) is carried out via the STS field.

15. Method according to claim 13, characterized in that the mobile device derives STS parameters from the rough positioning and the position data contained therein for STS generation.

16. Method according to claim 13, characterized in that key information is included in the STS generation.

17. Method according to claim 13, characterized in that time information is included as a parameter in the STS generation.

18. Method according to claim 13, characterized in that the synchronization message comprises a SYNC field for the temporal initialization of the receiver.

19. Method according to claim 13, characterized in that the sequence of the STS field and the data field vary within the synchronization message.

20. Method according to claim 13, characterized in that different clusters (C) use different STS sequences.

21. Method according to claim 13, characterized in that a cluster position is formed by averaging the positions of the network nodes (N) of a cluster (C).

22. Method according to claim 13, characterized in that a cluster (C) is bounded by walls in such a way that a spatially contiguous synchronization cluster is formed.

23. Method according to claim 13, characterized in that the synchronization message is encrypted.
